(19) United States
(12) Patent Application Publication
(10) Pub. No.: US 2014/0112165 A1
(43) Pub. Date: Apr. 24, 2014

(54) Channel estimation method for TD-SCDMA

(71) Applicant: BEIJING YUANWEIDA TECHNOLOGY CO.,LTD, Beijing (CN)

(72) Inventor: Jun Yan, Beijing (CN)

(73) Assignee: BEIJING YUANWEIDA TECHNOLOGY CO.,LTD, Beijing (CN)

(21) Appl. No.: 13/656,712

(22) Filed: Oct. 21, 2012

(51) Int. Cl. H04W 24/00

(52) U.S. Cl. 370/252

(57) ABSTRACT

A channel estimation method for TD-SCDMA system includes: sending midamble data to channel estimator and estimating the serving cell and adjacent cell channel response; calculating the interference cell number and setting the iteration number for interference cancelation; providing a channel response to a channel noise-suppression module that outputs a suppressed channel response; applying adaptive iterative interference cancelation. The invention solves the difficulty about the estimation of channel in multicell system, thus improving the estimation accuracy and the system capacity.

### FIELD OF THE INVENTION

The present invention relates to a method for improving the channel estimation accuracy in mobile communications, and more particularly, related to a channel estimation method in multicell intra-frequency TD-SCDMA communication system.

### BACKGROUND

Code division multiple access system, such as TD-SCDMA, are interference-restricted systems. A TD-SCDMA system can be an intra-frequency network, or inter-frequency network. When it is an inter-frequency network, multiple access of several cells is realized by frequency division. When it is intra-frequency, it is realized by compounded spreading codes.

In the case of an intra-frequency network, at the cell edge, user equipment will receive interference either from its own cell, or from the other cells. The channel estimation should be calculated correctly in order to use joint detection to improve the receiving performance. In single cell, as there is no interference from other cells, the channel estimation is much easier. However, in multicell case, the channel estimation is much more complex due to the interference. Therefore, in intra-frequency network, the channel estimation method is important. Otherwise, the capacity and successful hand over of the system might be decreased to a great extent.

### SUMMARY OF THE INVENTION

A channel estimation method for multicell in a TD-SCDMA system is disclosed, in order to suppress the interference received by the user equipment in an intra-frequency network from its own cell and the adjacent cells, and to combat the problems of low capacity and handovers.

The steps of the noise and interference power estimation method are as follows:
A. Sending midamble codes to channel estimator and estimating the serving cell and adjacent cell channel response;
B. Calculating the interference cell number and setting the iteration time for interference cancelation;
C. Providing a channel response to a channel noise-suppression module that outputs a suppressed channel response;
D. Applying adaptive iterative interference cancelation;
E. Checking whether the iteration number meets the maximum preset number.

In step A, the channel estimation comprises:
Spliting data and getting the Midamble data;
Using Midamble data to calculate channel estimation by steiner method;

In step B, calculating the interference cell number and setting the iteration number comprises:
Calculating the total channel power of the local cell and adjacent cells;
Multiplying the channel power of the local cell with a coefficient, β(0<β<1) as a threshold to choose the interference cell;
Setting the iteration number to be L+1 wherein L is the interference cell number;

In step C, a suppressed channel response \tilde{H}ₙ for nth cell comprising:
Calculating window powers and picking up the window with the maximum power Wₘₐₓ as the main window;
Picking up useful taps in the main window and recording the positions of the taps;
Choosing useful windows and the useful taps in the windows;
Averaging channel responses of the main window and useful windows;
Calculating SNR of the cell;

In step D, applying adaptive iterative interference cancelation is according to the following formula:

$${r}^{i + 1} = {r}^{i} - {\sum }_{n = 1}^{L} {φ}_{n} {M}_{n} {\tilde{H}}_{n}$$

Wherein Mₙ is the training matrix of nth cell, rⁱ is the training signal for ith iteration, φₙ is the cancellation weight for nth cell.

### BRIEF DESCRIPTION OF THE DRAWINGS

FIG. 1 is a schematic diagram of the midamble code structure

FIG. 2 is a schematic diagram of the channel estimation process

FIG. 3 is a schematic diagram of the channel denoising process

### DETAILED DESCRIPTION OF THE INVENTION

This invention is further exemplified with the use of the figures and the embodiments.

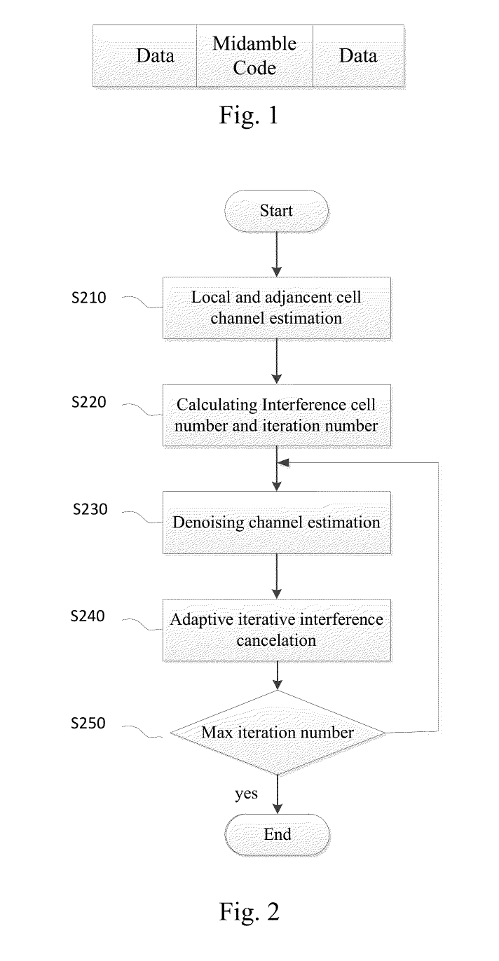

The burst structure of TD-SCDMA is shown in FIG. 1. Midamble data lies in the middle of the burst for channel estimation, information data lies in the front and back of the burst. In multicell system, Midamble data is used for channel estimation as well. Therefore, data should be splited and Midamble data should be obtained and sent to channel estimation module to estimate the channel response for the serving cell and adjacent cells.

FIG. 2 is the process to estimate the channel response. According to FIG. 2, in step S210, channel estimation for serving cell and adjacent cell can be applied in time or frequency domain. Firstly, with the input of Midamble data, Steiner estimator can be applied for each cell to get the rough single cell channel estimation. Taking local cell as example, the channel estimation is achieved by H₀=IFFT(FFT(r)./FFT(m)), where r is the receiving midamble data, m is the midamble sequence of local cell. H₀={h₁, h₂, . . . , h₁₂₈}, where hᵢ is the ith tap of the channel response. The channel estimation of other adjacent cells Hₙ can be achieved by the same way.

In step S220, calculating the channel power for local cell and adjacent cells respectively. The power of local cell is P₀=|H₀|². The power of adjacent cell is Pₙ=|Hₙ|², n=1, . . . , N. The interference cell is chosen with the following formula:

Pₙ>βP₀(0<β<1)

After calculating the number of interference cell, suppose the number is L, the iteration number is L+1.

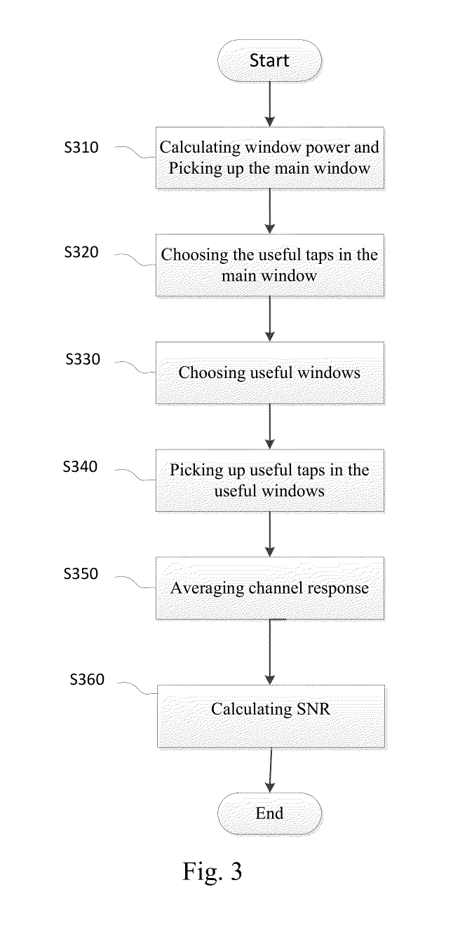

Since each channel estimation result, Hₙ, involves noise and interference, it should be suppressed to get the useful channel estimation \tilde{H}ₙ. The channel estimation is sent to the noise-suppression module. The detailed steps are introduced in FIG. 3.

In step S310, suppose each channel has 8 windows and the window length is 16. The window power Wᵢ (i=1, . . . , 8) is calculated based on the following formula:

$${W}_{i} = {\sum }_{n = 1}^{16} {\vert {h}_{( i - 1 ) \times 16 + n} \vert}^{2}$$

The window with the maximum power Wₘₐₓ is chosen as the main window.

In step S320, noise-suppression module calculates the power of each tap |hᵢ|² in the main window. Then it chooses the tap with the maximum power |hₘₐₓ|² as the main tap and recording the position of the main tap.

In step S330, other useful taps in the main window should be picked up and recorded along with the main taps as the channel usually has multiple paths. The power of other taps are compared with that of the main tap and the ones which is larger than the threshold are saved as the useful taps.

$${h}_{i} = \{ \begin{matrix}{h}_{i} , & {\vert {h}_{i} \vert}^{2} > α {\vert {h}_{max} \vert}^{2} \\ 0 , & {\vert {h}_{i} \vert}^{2} < α {\vert {h}_{max} \vert}^{2}\end{matrix}$$

Where 0<α<1. Specially, α=0.7 in this example.

In step S340, useful windows are picked out whose power are larger than the threshold, which is shown as follows:

Wᵢ>γWₘₐₓ, 0<γ<1

Specially, γ=0.6 in this example.

In step S350, useful taps in useful window are picked out according to the positions of useful taps in the main window. The channel responses of useful taps are kept and other taps are set to 0.

In step S360, the channel responses of the useful windows and main window are averaged to get the noise-suppressed channel response \tilde{H}ₙ.

In step S370, SNR (signal to noise ratio) is calculated, which is denoted as λ.

λ=|\tilde{H}ₙ|²/σ²

Where σ² is noise power, which is sum power of the smallest 64 taps.

In step S240, the adaptive iteration interference cancellation is according to the following formula:

$${r}^{i + 1} = {r}^{i} - {\sum }_{n = 1}^{L} {φ}_{n} {M}_{n} {\tilde{H}}_{n}$$

Where Mₙ is the training matrix based on the training sequence of nth cell, rⁱ is the training signal for ith iteration. φₙ is the iteration weight for nth cell. φₙ is calculated based on the SNR ratio. Suppose the local cell has the largest SNR, then φ₀=1. The weight of nth cell is φₙ=λₙ/λ₀. When rⁱ⁺¹ is obtained, step S210 and S230 are used to do channel estimation and noise suppression again.

In step S250, judge whether the iteration has achieved the maxim iteration number preset in step S220. If the number is achieved, the channel estimation is over, otherwise, go back to S230 and S240.

What is stated above is just an example of the embodiments of this invention, and is not meant to be restricting on the scope of the present invention. Any equivalent modification or adjustment of the scope of the invention falls within the scope of the present invention.

1. A channel estimation method for TD-SCDMA, comprising:
Sending midamble codes to channel estimator and estimating the serving cell and adjacent cell channel response;
Calculating the interference cell number and setting the iteration number for interference cancelation;
Providing channel response to a channel noise-suppression module that outputs a suppressed channel response;
Applying adaptive iterative interference cancelation;
Checking whether the iteration number meets the maximum preset number.

2. The method of claim 1 wherein estimating the serving cell and adjacent cell channel estimation comprises:
Spliting data and getting the Midamble data;
Using Midamble data to calculate channel estimation by steiner method.

3. The method of claim 1 wherein calculating the interference cell number and setting the iteration times comprises:
Calculating the total channel power of the local cell and adjacent cells;
Multiplying the channel power of the local cell with a coefficient β(0<β<1) as a threshold to choose the interference cell;
Setting the iteration number to be L+1 wherein L is the interference cell number.

4. The method of claim 1 wherein outputting a suppressed channel response \tilde{H}ₙ comprises:
Calculating window powers and picking up the window with the maximum power Wₘₐₓ as the main window;
Picking up useful taps in the main window and recording the positions of the taps;
Choosing useful windows and the useful taps in the windows;
Averaging channel responses of the main window and useful windows;
Calculating SNR of the cell.

5. The method of claim 4 wherein picking up useful taps in the main window comprises:
Choosing the taps with the maximum power as the main tap;
Multiplying the maximum power with a coefficient α(0<α<1) as a threshold to choose the useful taps.

6. The method of claim 4 wherein picking up useful windows and useful taps in the window comprises:
Multiplying the maximum window power with a coefficient γ(0<γ<1) as a threshold to choose the useful windows;
Picking up the useful taps in the useful window according to the position recorded in the main window.

7. The method of claim 1 wherein applying adaptive iterative interference cancelation is according to the following formula:
$${r}^{i + 1} = {r}^{i} - {\sum }_{n = 1}^{L} {φ}_{n} {M}_{n} {\tilde{H}}_{n}$$
Wherein Mₙ is the training matrix of nth cell, rⁱ is the training signal for ith iteration, φₙ is the cancellation weight for nth cell.

8. The method of claim 7 wherein the cancelation weight is obtained based on the SNR ratio of different cells involved in the iteration cancellation.
